(19) United States
(12) Patent Application Publication
(10) Pub. No.: US 2005/0100256 A1
(43) Pub. Date: May 12, 2005

(54) Single plate hydrodynamic bearing cartridge

(75) Inventors: Lakshman Nagarathnam, Capitola, CA (US); Hans Leuthold, Santa Cruz, CA (US); David Jennings, Santa Cruz, CA (US); Norbert Parsoneault, Watsonville, CA (US); Wesley R. Clark, Watsonville, CA (US); Gunter Heine, Aptos, CA (US)

Correspondence Address: MOSER, PATTERSON & SHERIDAN LLP/;SEAGATE TECHNOLOGY LLC, 595 SHREWSBURY AVENUE, SUITE 100, SHREWSBURY, NJ, 07702, US

(73) Assignee: SEAGATE TECHNOLOGY LLC.

(21) Appl. No.: 10/400,082

(22) Filed: Mar. 24, 2003

Related U.S. Application Data
(62) Division of application No. 08/976,373, filed on Nov. 21, 1997, now Pat. No. 6,702,408.
Application No. 08/976,373 is a continuation of application No. 08/546,932, filed on Oct. 23, 1995, now abandoned.

(51) Int. Cl. F16C 32/06

(52) U.S. Cl. 384/107

(57) ABSTRACT

A hydrodynamic bearing having a shaft relatively rotatable with respect to a surrounding sleeve and having a thrust plate on one end thereof rotating in a recess of the sleeve. The shaft is preferably interrupted by a equi-pressure groove accessing a central reservoir in the shaft and having journal bearings defined by herringbone patterns above and below the groove to stabilize and provide stiffness to the cartridge. The stiffness of the cartridge is further enhanced by a thrust plate carried at one end of the shaft and rotating in a recess of the sleeve and being used to define thrust bearings on either surface.

### RELATED APPLICATIONS

This application is related to and may be used in common with the invention disclosed in A-60203/JAS, entitled “Vacuum Fill Technique for Hydrodynamic Bearing”, U.S. Ser. No. 08/503,568, filed Jul. 18, 1995, inventor: Parsoneault; A-60465/JAS entitled “Absorbent Oil Barrier”, unfiled, inventor: Parsoneault; A-60464/JAS entitled “Thrustbearing Built with Single Sided Grooved Plates”, unfiled, inventor: Leuthold; A-59788/JAS entitled “Single Plate Hydrodynamic Bearing with Fluid Circulation Path and Self Balancing Fluid Level”, U.S. Ser. No. 08/278,754, filed Jul. 22, 1994, inventor: Leuthold, all of said applications being assigned to the assignee of the present invention and incorporated herein by reference.

### FIELD OF THE INVENTION

The present invention relates to the field of hydrodynamic bearing assemblies, and especially to such assemblies adapted to have good stiffness and long useful life.

### BACKGROUND OF THE INVENTION

Many motors, spindles and the like are based on bearing cartridges comprising a shaft and sleeve and bearings supporting these two elements for relative rotation. For example, a shaft may be mounted by means of two ball bearings to a sleeve rotating around the shaft. One of the bearings is typically located at each end of the shaft/sleeve combination. These bearings allow for rotational movement between the shaft and the hub while maintaining accurate alignment of the sleeve to the shaft. The bearings themselves are normally lubricated by grease or oil.

The conventional bearing system described above is prone, however, to several shortcomings. First is the problem of vibration generated by the balls rolling on the raceways. Ball bearings in such cartridges frequently run under conditions that result in physical contact between raceways and balls; this occurs in spite of the lubrication layer provided by the bearing oil or grease. Hence, bearing balls running on the generally even and smooth, but microscopically uneven and rough raceways, transmit this surface structure as well as their imperfections in sphericity in the form of vibration to the rotating element. This vibration results in misalignment between whatever device is supported for rotation and the surrounding environment. This source of vibration limits therefore the accuracy and the overall performance of the system incorporating the cartridge.

Another problem is related to damage caused by shocks and rough handling. Shocks create relative acceleration between stationary and rotating parts of a system which in turn shows up as a force across the bearing system. Since the contact surfaces in ball bearings are very small, the resulting contact pressures may exceed the yield strength of the bearing material and leave permanent deformation and damage on raceways and balls, which would also result in tilt, wobble, or unbalanced operation of the bearing.

Moreover, mechanical bearings are not always scalable to smaller dimensions. This is a significant drawback since the tendency in the high technology industry has been to continually shrink the physical dimensions.

As an alternative to conventional ball bearing spindle systems, researchers have concentrated much of their efforts on developing a hydrodynamic bearing. In these types of systems, lubricating fluid—either gas or liquid—functions as the actual bearing surface between a stationary base or housing and the rotating spindle or rotating hub and the stationary surrounding portion of the motor. For example, liquid lubricants comprising oil, more complex ferro-magnetic fluids, or even air have been utilized for use in hydrodynamic bearing systems. Such bearings scale well to small sizes without being prone to many of the defects of ball bearings outlined above. Because of the lack of metal-to-metal contact, the bearing has a long life. Because of the stiffness of the bearing, it is highly stable and useful as a reference in devices such as optical encoders and the like.

However, it is apparent that a difficulty with such a hydrodynamic bearing design is their sensitivity both to machining tolerances and the temperature ranges across which they are utilized. Both of these issues are critical in hydrodynamic bearings, because the very narrow gaps between the rotating and stationary parts must be maintained so that the fluid is effective in lubricating the bearing surfaces. Further, the tolerances between the surfaces of the bearing must be very fine so that no tilting or misalignment between the two parts occurs. In other words, it is important to have a very stiff bearing which does not allow for any tilting of the rotating part relative to the stationary part. A further difficulty with prior art designs is that frequently voids or gas bubbles occur in the bearing area, thereby reducing the effective bearing surface and the related load capacity.

Thus it is clear that a number of considerations must be balanced in designing an effective hydrodynamic bearing cartridge, regardless of the area in which it will eventually be utilized.

### SUMMARY OF THE INVENTION

It is therefore a primary objective of the present invention to provide a hydrodynamic bearing which is simple in design, and highly adaptable and scalable for use in many different environments. It is a further objective of the invention to provide a hydrodynamic bearing having a reliable, repeatable design so that the bearing has the necessary stiffness to be used in applications which have no tolerance for tilt, wobble, or other inaccuracies.

It is a further and related objective of the present invention to provide a hydrodynamic bearing in which the fluid circulation is controlled and directed so that the wear and tear on the two prior surfaces defining the bearing is minimized.

Another related objective of the present invention is to provide for fluid circulation within the hydrodynamic bearing such that the possibility of voids within the lubricant is minimized.

A related objective of the invention is to provide a hydrodynamic bearing design having optimized boundary conditions between the various sections of the bearings to optimize fluid flow and diminish sensitivity to temperature and machining tolerances, thereby providing a greater consistency in the dynamic performance of the invention.

These and other objectives are achieved by providing a hydrodynamic bearing having a shaft relatively rotatable with respect to a surrounding sleeve and having a thrust plate on one end thereof rotating in a recess of the sleeve. The shaft is preferably interrupted by a equi-pressure groove accessing a central reservoir in the shaft and having journal bearings defined by herringbone patterns above and below the groove to stabilize and provide stiffness to the cartridge. The stiffness of the cartridge is further enhanced by a thrust plate carried at one end of the shaft and rotating in a recess of the sleeve and being used to define thrust bearings on either surface thereof. In a typical embodiment, chevron patterns may be coined or etched on both surfaces of the thrust plate so that appropriate pressure patterns can be set up between the thrust plate surface and either a shoulder of the sleeve or a facing counterplate. Alternatively, a counterplate may be provided in which the chevron pattern is stamped thereon, and may in a preferred embodiment even extend beyond the edges of the thrust plate and the recess in which it rotates so that disturbances to the pressure patterns are minimized.

### BRIEF DESCRIPTION OF THE DRAWINGS

The features and advantages of the present invention will be better understood by reference to the following drawings wherein

FIG. 1 is a figure used to illustrate the basic operating principles of a hydrodynamic bearing;

FIG. 2 is a vertical sectional view of a bearing cartridge in accordance with the present invention utilizing a rotating shaft;

FIG. 3 is an alternative embodiment of a hydrodynamic bearing cartridge utilizing a rotating shaft; and

FIG. 4 is a vertical sectional view of a hydrodynamic bearing cartridge utilizing a fixed shaft.

### DETAILED DESCRIPTION OF A PREFERRED EMBODIMENT

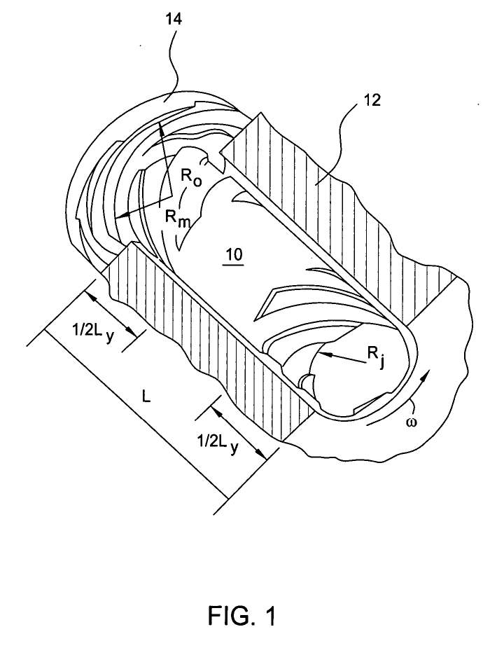

The basic principles of the present invention are derived from hydrodynamic bearings as already known in the technology, an example of which is shown in FIG. 1. As shown in this figure, a journal bearing includes a shaft 10 which is rotating relative to a bushing or a sleeve 12, with one of the opposing two surfaces (in this case the shaft closed) carrying cylindrical sections of spiral grooves. A thrust plate 14 may also be provided at or near one end of the shaft 10 carrying concentric spiral groove sections either on the plate itself or on the sleeve surface that it faces. Relative rotation of the shaft churns and pumps the fluid as a function of the direction, width, and angle of the grooves with respect to the sense of rotation. The pumping action builds up multiple pressure zones along the journal and the thrust plates, maintaining a fluid film between the rotating parts and providing the desired stiffness for the bearing.

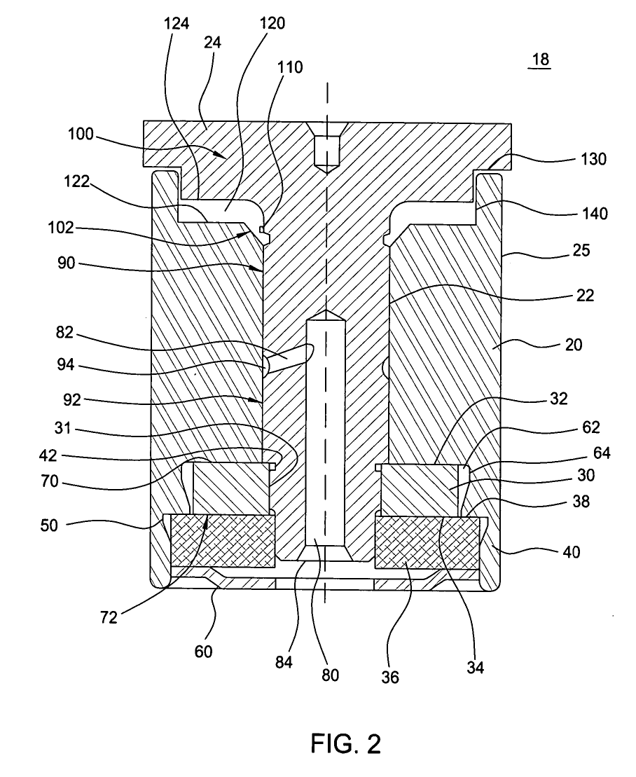

FIG. 2 is a first example of a hydrodynamic bearing incorporating the principles of the present invention. The basic elements of the hydrodynamic bearing include a sleeve 20 which is preferably a single solid stationary piece which on its interior surface 22 defines the outer circular surface of the journal bearing formed by this circular, stationary sleeve and the rotating shaft 24 which rotates inside this sleeve 20. In this exemplary embodiment of a hydrodynamic bearing cartridge, the sleeve 20 is preferably a single solid piece whose outside surface will form the outer shell 25 of the overall cartridge 18.

At the lower end of the shaft 24 near its base end, a thrust plate 30 is stepped into the shaft. This thrust plate 30 extends into a recess defined in this particular embodiment by a lower horizontal surface 32 of the sleeve 20 and an upper surface 34 of a counterplate 36. In this embodiment the counterplate 36 is shown as an element separate from the sleeve 20, pressed in place against a step 38 and inside a shoulder 40 of the sleeve. Other approaches to the assembly for defining this recess are also available and within the scope of the invention. The thrust plate 30 is stepped into the recess 31 of the shaft 24, taking advantage of a small indentation 42 in the shaft 24 which allows the thrust plate to be more easily pressed into place. A small recess 50 is also provided in the sleeve 24 at the top of the shoulder 40 to allow the counterplate 36 to be stepped into place. The recess 50 terminates in the step 38 of the sleeve 20 which is important in locating the vertical spacing of the counterplate 36. The axial location of the counterplate 36 will define the gap between the counterplate 36 and thrust plate 30, forming an operative portion of the hydrodynamic bearing. Immediately below the counterplate 36 is located a shield 60 which is provided to close the bottom region of the bearing assembly, below the rotating shaft 24, from the outside working environment.

With respect to the lower thrust bearing which the thrust plate 30 is the primary component, this thrust plate is rotating in a recess defined by the sleeve surface 32 facing the upper side of the thrust plate, the sleeve recess 62 and recess defining surface 64 which extend along the outer diameter of the thrust plate, and the counterplate 36 captured in the shoulder 40 of the sleeve. The effective surfaces of the thrust bearing in maintaining the stability of the rotating system are the gap 70 between the upper surface of the thrust plate and the bottom shoulder 32 of the sleeve, and the gap 72 between the lower surface of the thrust plate and the upper surface of counterplate 36. The fluid will circulate through these gaps 70 and 72 and the reservoir 62, establishing and maintaining the axial force equilibrium which results form the thrust forces or lifts created in the gaps 70 and 72 and any external axial force applied to the rotating shaft 24 with respect to the sleeve 20.

In addition to the fluid present in the gaps between the rotating shaft 24 and sleeve 20, and between the thrust plate and sleeve and thrust plate and counterplate, fluid is also provided in a reservoir 80 incorporated into the center of the shaft 24, and communicating with the gap 22 between shaft 24 and sleeve 20 through a bore 82. Generally speaking, the direction of fluid flow through the hydrodynamic bearing will be from the reservoir 80 through the lower opening 84 of the reservoir and between the rotating shaft 24 and counterplate 36, through gap 72, reservoir 62 and gap 32 and through the gap 22 between rotating shaft 22 and sleeve 20. This fluid circulation with its accompanying definition of supporting pressure waves, is enhanced by herringbone patterns pressed, coined, or otherwise defined on the upper surface 32 and lower surface 34 of the thrust plate carried on the rotating shaft, as well as the chevron or herringbone style patterns known in this technology and carried on one of the surfaces of the rotating shaft 24 or sleeve 20 facing the defining gap 22.

The development of these pressure differentials is enhanced by the use of a herringbone pattern such as shown in FIG. 5 on one of the surfaces of either side of the gap 70 and 72 defined between the thrust plate and the surface it faces.

The fluid circulation and pressure differentials which maintain and enhance the stiffness of the hydrodynamic bearing are further created by the use of upper and lower journal bearings 90, 92 defined between the rotating shaft 24 and sleeve 20. Alternate embodiments with spiral grooves defined on the rotating shaft that is the outside surface of the rotating shaft 24 instead of on the internal bushing of the stationary sleeve are also available without significantly altering the behavior of the design.

The upper and lower internal bearings 90, 92 are separated by the bore 82 which communicates with reservoir 80 and ends in an equi-pressure groove 94. This groove is at the edge of the rotating shaft 24 adjacent the interior surface of sleeve 24. The upper and lower bearings 90, 92 are further defined by a herringbone pattern preferably comprising multiple (at least two) spiral groove axial sections pressed or otherwise defined into the surface of the sleeve 70. The geometry of this pattern is such as will be described further below that relative motion between the sleeve 20 and rotating shaft 24 surfaces will build up a positive pressure with respect to both ends of the bearing, thereby enhancing the desired fluid circulation through the bearing and maintaining the fluid within the bearing rather than allowing it to escape into the environment in which the hydrodynamic bearing is used.

The upper journal bearing 90 that is the bearing between the reservoir exit bore 82 and the rotating head cap portion 100 of the shaft 24 is also defined between the rotating outer surface of the rotating shaft 24 and the internal surface of sleeve 20. The bearing has a similar grooved pattern as described with respect to the lower journal bearing that is a herringbone pattern such that positive pressure is built up and established with respect to both ends of the bearing that is the end near to the reservoir exit bore 82, and the other end near to the upper tapered surface 102 of the outer sleeve 20.

As previously mentioned, the path of the circulation of the fluid past the journal bearing and thrust bearing includes equi-pressure groove 94 and radial bore 82, and a reservoir 80 which comprises a center bore in the rotating shaft, filled with lubricant. If gas bubbles or a void should appear in the fluid, they are likely to be trapped in this center bore due to the centrivical force differential between the heavier circulating fluid and the lighter bubble, thereby diminishing the prospect of a bubble or a void appearing in one of the thrust or journal bearings. Any such bubble or void can diminish the stiffness of the bearing, and lead to accelerated wear in the bearing. This feature is especially important during the assembly process, where it is used to fill and bleed the bearing properly, with the voids being bled out as they accumulate in the reservoir.

It should also be noted that the radial thrust plate gap or cavity 62 adjacent the end of the radial thrust plate 30 and define between that and in the interior wall 64 of sleeve 20 is also filled with lubricant. The cavity is large enough to enforce an infinite manifold boundary condition between the two thrust bearings defined in gaps 32, 34. The upper equi-pressure groove 94 and radial bore 82 connect the upper boundary of the lower journal bearing 92 and the lower boundary of the upper journal bearing 90 to the reservoir 80, thus enforcing an ambient pressure boundary condition. The circulating fluid thus can leave the journal bearing through the radial bore 82 and travel into the center bore reservoir 80 in order to maintain proper fluid circulation. A middle equi-pressure groove (not shown) may also be provided at the junction or intersection between the lower journal bearing 92 and the upper thrust bearing 32. This groove would fill with lubricant and would be large enough to enforce an infinite manifold boundary condition between the upper thrust bearing and lower journal bearing to further aide in the development of the proper pressure distribution across these surfaces.

The hydrodynamic bearing of the present invention further includes a capillary seal generally indicated at 110. It is formed at the radial gap between the rotating shaft 24 and the sleeve 20, the gap between these two facing surfaces of the two members having a progressively increasing width 102. The capillary action due to the surface tension in the bearing fluid prevents the fluid in the hydrodynamic bearing from spilling out of the bearing in a standstill condition.

The bearing further includes an enlarged recess 120 above the capillary seal 110 and defined between an upper shoulder 122 of the sleeve and a lower surface 124 of the rotating shaft. This gas trap 120 inhibits any net gas or fluid flow out of the bearing assembly to the atmosphere surrounding the assembly. However, gasses may still leave the fluid at the upper boundary of the upper journal bearing. Further, lubricant droplets created under excessive shock may also be defined to be collected in the same gas trap 170.

The ability to prevent exiting of particles or gasses from the hydrodynamic bearing is further enhanced by a seal 130 formed by the curved wall of the upper hub end of the rotating shaft rotating over the upright shoulder of the sleeve 20.

As a further protection against any escape of gas or the like, the lower surface 124 of the hub end of the shaft 24 and the horizontal surface 122 of the upper main body portion of the sleeve.

As a further protection, the surfaces 122, 124 of the gas trap reset may be colored with a non-wetting material to prevent fluid creep from the bearing into the gas trap. These coatings may also be applied to both the surfaces of the seal generally indicated at 130. The use of these barrier coatings may be significant because without them the seal may lose much of its sealing function, since evaporation from a wet surface will maximize in a narrow gap.

The other circumferential surface 140 of the gas trap, defined by an inner surface of the sleeve, may also be coated with holder ring of absorbent material on the surface thereof. This will eliminate condensing gasses and bind droplets accumulating in the gas trap 120.

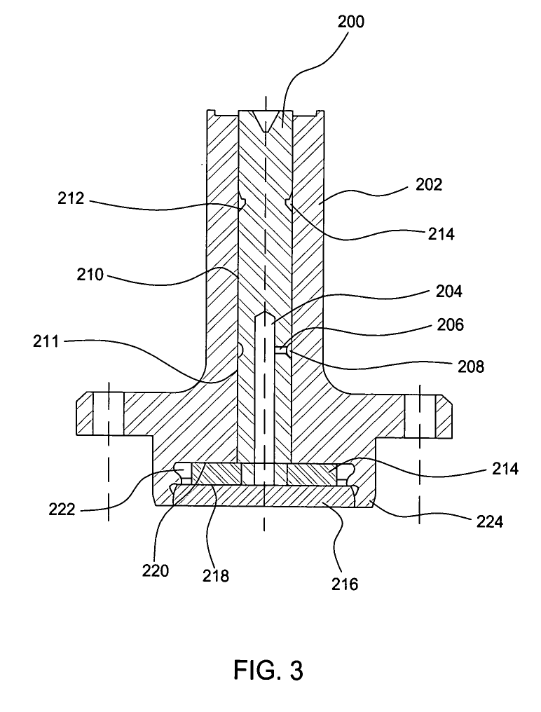

A second rotating shaft hydrodynamic bearing is shown in FIG. 3. The hydrodynamic bearing of FIG. 3 also includes a rotating shaft 200 which in this embodiment is a straight stem rising up through a sleeve 202. The rotating shaft includes a fluid reservoir 204 connected through a bore 206 and equi-pressure groove 208 to the facing surfaces of the rotating shaft 200 in sleeve 202 which form the hydrodynamic journal bearings. In this embodiment, chevron patterns in the regions 210, 212 form journal bearings above and below the equi-pressure groove. The upper bearing to region 210 extends up to a region 212 where the surface of the rotating shaft angles away from the facing surface of the sleeve. A small shoulder 214 in the sleeve faces the notch 212 formed in the rotating shaft 200. This allows the formation of a capillary seal at the lower portion of the notch 212 extending from the rotating shaft across to the interior surface of the sleeve so that fluid cannot escape above this region.

The lower journal bearing 212 extends substantially down to a thrust plate 214 where the shaft terminates, with the reservoir 204 extending down through this thrust plate. As described in greater detail in the incorporated Leuthold et al. application, a counterplate 216 faces the bottom surface of the thrust plate 214. In a preferred embodiment, the chevron or herringbone patterns which are needed to establish the proper pressure distributions across the hydrodynamic bearing are formed on the upper surface 218 of this counterplate, facing the flat bottom surfaces of the thrust plate 214. Herringbone or chevron patterns are also formed on the upper surface 220 of the thrust plate facing the top surface of the recess 222 in which the thrust plate rotates so that both upper and lower thrust bearings are formed to enhance the lateral and axial stability of the rotating shaft in the hydrodynamic bearing. This arrangement incorporating a counterplate inserted between the shoulder 224 of the sleeve 202 forms a hydrodynamic bearing having a very flat bottom surface and a tall thin profile which has many potential uses.

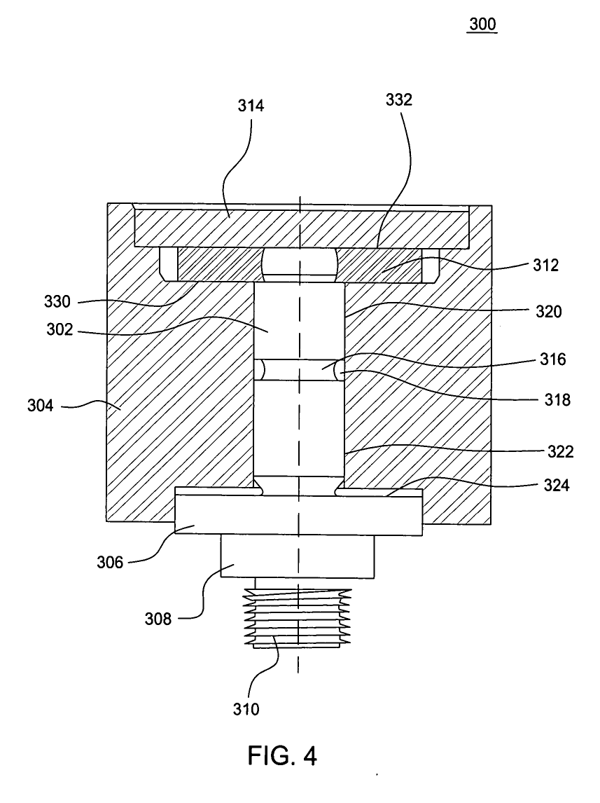

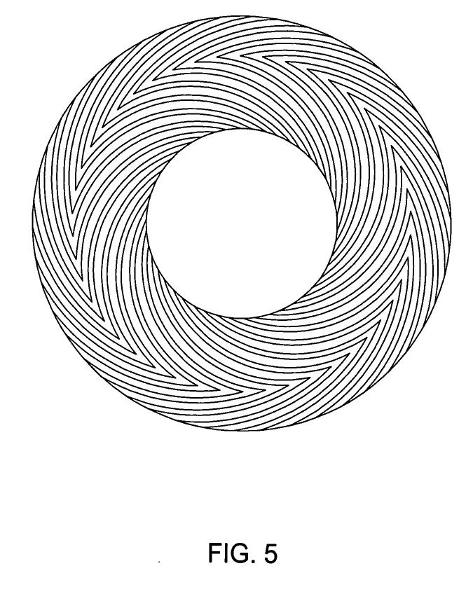

FIG. 4 illustrates a hydrodynamic bearing cartridge incorporating a stationary shaft. The operating principles of the cartridge can be found in application of Leuthold et al., U.S. Ser. No. 08/278,754, filed Jul. 22, 1994 and incorporated herein by reference. Thus the bearing cartridge 300 includes a shaft 302 surrounded by a rotating sleeve 304. The shaft supports a thrust plate 306 at one end, which in turn is supported by a shoulder 308 and nut 310. The shoulder and especially the nut are provided so that the fixed shaft bearing cartridge can be incorporated into any system in which the cartridge is to be used. The shaft includes a second thrust plate 312 at its opposite end. The sleeve 304 has up-raised shoulders, and a counterplate 314 is pressed and supported in place between the shoulders and rotates over the thrust plate 312. The fluid flow in the hydrodynamic bearing, in addition to being through the center reservoir (not shown) of the shaft and through the axis bore 316 and equalization for 318 flows out to upper and lower journal bearings 320, 322. These bearings are formed by chevron patterns and pressed either on the outer surface of the shaft 302 or inner surface of the rotating sleeve 304 in accordance with the principles discussed above. Further chevron or herringbone patterns are coined or impressed on the upper surface 324 of counterplate 306 so that fluid will also flow over this surface allowing the free rotation of the sleeve relative to the thrust plate while maintaining the stability of the system. At the opposite end of the fixed shaft, the surface 330 of thrust plate 312 which faces the sleeve 304 also has a herringbone pattern to create the desired pressure distribution over this fluid bearing surface. On the opposite side of the thrust plate 312, either the thrust plate itself, or preferably the counterplate 314 will have on its surface 332 the desired herringbone pattern to create the pressure distributions which are necessary to and characterize the bearing cartridge.

In all other respects the cartridge operates according to the same principles described above with respect to rotating shaft hydrodynamic bearing cartridges.

Other features and advantages of the present invention will become apparent to a person of skill in this field who studies the present invention disclosure. For example, the embodiments of both FIGS. 3 and 4 could be used as either rotating and stationary shaft motors. Therefore, the scope of the present invention is to be limited only by the following claims.

1. A hydrodynamic bearing cartridge comprising a sleeve and a shaft fitted into an axial bore of said sleeve,
said shaft and said sleeve rotating freely relative to one another, and together defining a journal bearing, said shaft further supporting an annular thrust plate, said thrust plate extending into a recess formed by an axial face stepped into said sleeve and
a counterplate parallel to said axial face and said thrust plate and attached to said sleeve,
said surface of said thrust plate facing said axial face of said sleeve having a groove pattern formed thereon, and said surface of said counterplate facing an opposed, second surface of said thrust plate having a grooved pattern thereon, to form an effective fluid pumping surface in said hydrodynamic bearing.

2. A cartridge as claimed in claim 1 wherein said shaft is stationary, and said sleeve supports a hub for rotation with said sleeve about said stationary shaft and supported for rotation by a hydrodynamic bearing formed by said shaft, said thrust plate surface cooperating with said axial recess of said sleeve and said counterplate surface cooperating with said second surface of said thrust plate.

3. A cartridge as claimed in claim 2 wherein said counterplate is located between upright shoulders of said sleeve and located parallel to said thrust plate supported by said shaft.

4. A cartridge as claimed in claim 3 wherein said shaft terminates in a region parallel to said annular thrust plate so that said planar surface of said counterplate forms a planar end of said hydrodynamic bearing.

5. A cartridge as claimed in claim 1 wherein said grooved surface of said counterplate extends beyond the region of said counterplate overlying said second surface of said thrust plate so that said groove surface on said counterplate is more easily formed.

6. A cartridge as claimed in claim 1 wherein said shaft is rotating within said sleeve,
said shaft being supported for rotation by said hydrodynamic bearing formed by said shaft and said sleeve, said thrust plate surface cooperating with said axial recess of said sleeve and said counterplate surface cooperating with said second surface of said thrust plate.

7. A cartridge as claimed in claim 6 wherein said thrust plate is supported on said shaft distant from said hub and adjacent said counterplate supported on said sleeve.

8. A cartridge as claimed in claim 7 wherein said counterplate is located between upright shoulders of said sleeve and located parallel to said thrust plate supported by said shaft.

9. A cartridge as claimed in claim 8 wherein said shaft terminates in a region parallel to said annular thrust plate so that said planar surface of said counterplate forms a planar end of said hydrodynamic bearing.

10. A cartridge as claimed in claim 2 wherein said grooved surface of said counterplate extends beyond the region of said counterplate overlying said second surface of said thrust plate so that said groove surface on said counterplate is more easily formed.

11. A hydrodynamic bearing cartridge comprising a sleeve and a shaft fitted into an axial bore or bushing of said sleeve, said shaft and said bushing rotating freely relative to each other, said shaft defining together with said bushing a journal bearing; said shaft further supporting an annular thrust plate, said thrust plate extending into a recess formed by an axial face stepped into said sleeve and a counterplate parallel to said thrust plate and attached to said sleeve, and said axial face defining together with the adjacent thrust plate surface a first thrust bearing, and the gap between said thrust plate and said counterplate forming a second thrust bearing, both thrust bearings opposing each other; furthermore, said counterplate defining a bore concentric to said shaft, said bore in said counterplate being closed off by a shield on the side opposing the stump of said shaft, thus creating a fluid filled bearing system which is open only on one end; said shaft further comprising an axial center bore serving as a reservoir for fluid for said fluid filled bearing system, said center bore communicating with said journal bearing through a first radial bore terminating adjacent said bushing defining said journal bearing, and with said thrust bearing through a flowpassage defined by gaps around said stump of the shaft of by a second radial bore in said shaft terminating adjacent to said second thrust bearing.

12. A bearing cartridge as claimed in claim 11 wherein said first bore divides said journal bearing into first and second journal bearings, each of said first and second journal bearings having at least a two-section herringbone pattern for creating a positive pressure differential from the boundaries towards the center, said journal bearing.

13. A bearing cartridge as claimed in claim 12 wherein said first journal bearing has a greater net grooved surface directing fluid flow toward said first radial bore than the net grooved surface defined by said herringbone pattern directing fluid flow away from said first radial bore.

14. A bearing cartridge as claimed in claim 11 wherein a first end of said journal bearing distal from said annular thrust plate terminates in a capillary seal formed between said bushing integral with said sleeve and said shaft.

15. A bearing cartridge as claimed in claim 14 wherein said surfaces of said bushing and said shaft where said capillary seal is formed are inclined away from each other to aid in the formation of said capillary seal.

16. A bearing cartridge as claimed in claim 14 including a gas trap defined by a horizontal surface of said bushing and said sleeve and a horizontal surface of said hub beyond said capillary seal for containing any fluid droplets condensation or gases in the bearing assembly.

17. A bearing cartridge as claimed in claim 16 further comprising a seal located beyond said gas trap and said capillary seal and defined between an extended surface of said sleeve and an inner surface of said hub for forming a barrier in a path between the capillary seal and the gas trap and the atmosphere surrounding said bearing assembly to prevent fluid evaporation.

18. A bearing cartridge as claimed in claim 11 having said first axial surface fixed against a recessed step in said shaft so that the net exposed wetted surface of the first thrust bearing is less than the net exposed wetted surface of the second thrust bearing, whereby the net fluid flow established around said thrust plate is from said second thrust plate surface toward said first thrust plate surface and thereby toward an end of said journal bearing.

19. A bearing cartridge comprising a shaft fitted into a sleeve or bushing with a liquid lubricant in between, said shaft and said bushing or sleeve freely relative to one another, said shaft defining together with said bushing a journal bearing, said shaft further supporting an annular thrust bearing extending through a recess defined by said lower surface of said bushing and an upper surface of a counterplate supported from said sleeve to define said recess, and said shaft comprising a center bore serving as a reservoir for fluid for said journal bearing and said thrust bearing, said central bore communicating with said journal bearing through a first bore terminating adjacent said bushing defining said journal bearing; and communicating with said thrust bearing through gaps around a first end of the shaft or through a second bore terminating adjacent said thrust bearing, said counterplate fitted on one side with a shield closing off the bearing and spindle from the outside.

20. A cartridge as claimed in claim 19 wherein said first bore divides said journal bearing into first and second journal bearings, each of said first and second journal bearings having at least a two-section herringbone pattern for creating a positive pressure differential from the boundaries towards the center said journal bearing.

21. A cartridge as claimed in claim 20 wherein said first journal bearing has a greater net grooved surface directing fluid flow toward said first radial bore than the net grooved surface defined by said herringbone pattern directing fluid flow away from said first radial bore.

22. A cartridge as claimed in claim 19 wherein a first end of said journal bearing distal from said annular thrust plate terminates in a capillary seal formed between said bushing integral with said sleeve and said shaft.

23. A cartridge as claimed in claim 22 wherein said surfaces of said bushing and said shaft where said capillary seal is formed are inclined away from each other to aid in the formation of said capillary seal.

24. A cartridge as claimed in claim 19 including a gas trap defined by a horizontal surface of said bushing and said sleeve and a horizontal surface of said hub beyond said capillary seal for containing any fluid droplets condensation or gases in the bearing assembly.

25. A cartridge as claimed in claim 22 further comprising a seal located beyond said gas trap and said capillary seal and defined between an extended surface of said sleeve and an inner surface of said hub for forming a barrier in a path between the capillary seal and the gas trap and the atmosphere surrounding said cartridge to prevent fluid evaporation.

26. A cartridge as claimed in claim 25 having said first axial surface fixed against a recessed step in said shaft so that the net exposed wetted surface of the first thrust bearing is less than the net exposed wetted surface of the second thrust bearing, whereby the net fluid flow established around said thrust plate is from said second thrust plate surface toward said first thrust plate surface and thereby toward an end of said journal bearing.

27. A cartridge as claimed in claim 24 wherein said thrust plate has first and second sides, each supporting a herringbone pattern comprising multiple spiral-grooved sections to form said first or second thrust bearings, the geometry of the patterns being selected so that relative motion between the fluid and the surface will build up a positive pressure between the outer diameter and the inner diameter of the plate surface.

28. A cartridge as claimed in claim 27 having said first axial surface fixed against a recessed step in said rotating shaft so that the net exposed wetted surface of the first thrust bearing is less than the net exposed wetted surface of the second thrust bearing, whereby the net fluid flow established around said thrust plate is from said second thrust plate surface toward said first thrust plate surface and thereby toward a lower end of said journal bearing.

29. A cartridge as claimed in claim 28 including an equipressure groove formed by a recess at the common junction of said rotating shaft, said bushing of said journal bearing and said upper thrust plate surface of said plate, said equipressure groove being filled with lubricant by said upper thrust bearing and said lower journal bearing.

30. A cartridge as claimed in claim 29 wherein said equipressure groove is formed by an inclined surface at the lower outer corner of said bushing adjacent said rotating shaft, and defining a cavity large enough to establish an infinite manifold boundary condition between said upper thrust bearing and said lower journal bearing.

31. A cartridge as claimed in claim 22 wherein said upper bore terminates in a circumferential equipressure groove connecting the lower boundary of the upper journal bearing to the upper boundary of the lower journal bearing and providing circulating fluid from the bearing through the radial bore into the center bore reservoir, and forcing an ambient pressure boundary condition for said upper and said lower journal bearing.

32. A cartridge as claimed in claim 31 including a lower equipressure groove terminating in a radial bore adjacent said thrust bearing or a gap between the counterplate and the shaft and the shaft and the shield and connecting the thrust bearing to the reservoir, and forcing an ambient pressure condition to allow the circulating fluid to enter the thrust bearing through the lower radial bore from the center reservoir.

33. A cartridge as claimed in claim 32 including a radial thrust plate gap defined between an outer end of said thrust plate and an inner surface of said sleeve and being wider than the gap defined between either said upper thrust plate surface and said bushing or said lower thrust plate surface and said counterplate and filled with lubricant to trap metal particles in a cavity due to the centrifugal force differential between the circulating fluid and the metal particles.

34. A cartridge as claimed in claim 26 including barrier coatings comprising a non-wetting material on the horizontal surfaces delimiting the gas trap to prevent fluid creep from the bearing into the gas trap.
